(19) United States
(12) Patent Application Publication
(10) Pub. No.: US 2005/0100781 A1
(43) Pub. Date: May 12, 2005

(54) Actively controlled metal-air battery and method for operating same

(76) Inventors: Kevin Jang, Fargo, ND (US); Wen Huang, Fargo, ND (US)

Correspondence Address: Wen C. Huang, 2902 28 AVE, S.W., FARGO, ND, 58103, US

(21) Appl. No.: 10/702,003

(22) Filed: Nov. 6, 2003

(51) Int. Cl. H01M 2/12; H01M 6/32

(52) U.S. Cl. 429/61; 429/82; 429/118; 429/127

(57) ABSTRACT

This invention provides an actively controlled electrochemical cell and a smart battery containing such a cell with a programmed-timing activation capability. As a preferred embodiment, the cell includes (a) a cathode, an anode, a porous separator electronically insulating the cathode from the anode, and an electrolyte, wherein the anode is initially isolated from the electrolyte fluid prior to the first use of the cell; (b) an actuator in actuation relation to the electrolyte or the anode; and (c) a control device in control relation to the actuator for sending programmed signals to the actuator to activate the cell by allowing a desired amount of an active anode material at a time to be exposed to the electrolyte during the first use and/or successive uses of the cell. The cell or battery has an essentially infinite shell life and an exceptionally long operating life. The battery is particularly useful for powering microelectronic or communication devices such as mobile phones, laptop computers, and palm computers.

### BACKGROUND OF THE INVENTION

1. Field of the Invention

The present invention relates to an electrochemical cell with an essentially infinite shelf life and an exceptionally long operating life. In particular, this invention relates to a metal-air cell and a battery containing such a cell, wherein the constituent anode material is incrementally activated on demand or in a programmed-timing manner to achieve an extended operating life and a better utilization of the anode energy capacity.

2. Brief Description of the Prior Art

Metal-air batteries produce electricity by the electrochemical coupling of a reactive metallic anode to an air cathode through a suitable electrolyte in a cell. During cell operation oxygen is reduced within the cathode while anode metal is oxidized, providing a usable electric current that flows through an external circuit connected between the anode and the cathode. Commercial air cathodes typically contain active carbon, a finely divided hydrophobic polymeric material, a dissociation-promoting catalyst, and a metal screen as a current collector. A variety of anode metals have been used or proposed for use in metal-air cells. However, zinc, lithium, aluminum, magnesium and alloys of these elements are considered especially advantageous due to their low cost, light weight, and ability to work with a variety of electrolytes.

The lithium-air cell is attractive because lithium has the highest theoretical voltage and electrochemical equivalence of any metal anode considered for a practical battery system. The cell discharge reaction of a Li-air cell may be written as:
2Li+1/2O₂+H₂O→LiOH, E°=3.35 V (1)
In continuous-use, high-drain discharge situations, the Li-air cell may operate at high coulombic efficiencies due to the formation of a protective film (scale) on the anode metal that could retard rapid corrosion after film formation. However, on open-circuit or low-drain discharge, the self-discharge of the lithium metal is rapid, caused by the parasitic corrosion reaction:
Li+H₂O→LiOH+½H₂ (2)
This reaction degrades the anode coulombic efficiency and may necessitate the removal of the electrolyte during stand (when the cell is not in use). This self-discharge reaction, which reduces the usable amount of anode material without providing useful current, must be minimized or eliminated if the full potential of the lithium anode is to be realized. Parasitic corrosion also presents a severe problem for all other types of metal-air cells. These considerations have led the present applicants to propose and demonstrate that the timing at which a controlled amount of an anode material is exposed to the electrolyte and the total length of anode-electrolyte interaction time may be manipulated in order to maximize the utilization potential of an anode metal material in an electrochemical cell, particularly a metal-air cell (but not limited to metal-air cells).

For metal-air cells such as zinc-air and aluminum-air, another major roadblock to wide-scale use in consumer electronics has been the life-limiting effect of exposure to ambient air. This exposure to ambient air, if not properly controlled, can severely shorten the operating life of a metal-air cell due to the negative effects of water transpiration and carbon dioxide adsorption on the electrolyte and the air electrode. Commercially available zinc-air button cells, for example, are sealed with tape over the air access holes at manufacture. This isolates the cells from the external ambient air until the consumer removes the tape prior to use. After removal of the protective tape, however, the cell has a limited life due to the negative effects of ambient air conditions. This observation suggests that it is also important to regulate the ingress of oxygen into the cell.

In summary, once oxygen is admitted into a metal-air cell and the anode is in contact with a liquid electrolyte, anode passivation, parasitic electrode corrosion and other discharge reactions (causing self-discharge or current leakage) could proceed regardless if the cell is being used or not. This effectively reduces the useful battery life and makes an inefficient use of the anode material. Specifically, state-of-the-art metal-air batteries have been found to exhibit the following shortcomings:
(1) Severe “anode passivation” problem: When the battery is run under high load, large amounts of aluminum hydroxide accumulate on the aluminum anode surface blocking the further access of anode by the electrolyte. In the case of zinc-air cells, zinc oxide layers prevent further access of zinc anode by the electrolyte. Such an anode passivation phenomenon tends to prevent the remaining anode active material from contacting the electrolyte since the remaining anode material is now effectively coated or surrounded by a ceramic layer. Consequently, the electron-generating function ceases and the remaining active anode material can no longer be used (hence, a low-utilization anode). All metal anodes used in state-of-the-art metal-air batteries are known to suffer from the anode passivation problem to varying degrees.
(2) Severe self-discharge and current leakage problems: “Self-discharge” is due to a chemical reaction within a battery that does not provide a usable electric current. Self-discharge diminishes the capacity of a battery for providing a usable electric current. For the case of a metal-air battery, self-discharge occurs, for example, when a metal-air cell dries out and the metal anode is oxidized by the oxygen that seeps into the battery during periods of non-use. Leakage current can be characterized as the electric current that is supplied to a closed circuit by a metal-air cell even when air is not continuously provided to the cell. These problems also result in a low-utilization anode.
(3) Severe corrosion problem: Four metals have been studied extensively for use in metal-air battery systems: zinc (Zn), aluminum (Al), magnesium (Mg), and lithium (Li). Despite the fact that metals such as Al, Mg, and Li have a much higher energy density than zinc, the three metals (Al, Mg, and Li) suffer from severe corrosion problems during storage. Hence, Mg-air and Al-air cells are generally operated either as “reserve” batteries in which the electrolyte solution is added to the cell only when it is decided to begin the discharge, or as “mechanically rechargeable” batteries which have replacement anode units available. The presence of oxygen tends to aggravate the corrosion problem. Since the serious corrosion problem of Zn can be more readily inhibited, Zn-air batteries have been the only commercially viable metal-air systems. It is a great pity that high power or energy density metals like Al, Mg and Li have not been extensively used in a primary or secondary cell.

There is a need for a battery that can be used as an emergency power source at locations where electric supply lines do not exist. Such a battery must have a high energy capacity and a high power density and be capable of running for a long period of time under high load. There is also a need for a battery or fuel cell that can provide a much extended “talk time” and “stand-by” time for a mobile phone. A need also exists for a battery that can power a notebook computer for a much longer period of time (e.g., 12 hours being needed to last for a trans-Pacific flight). Due to their high energy-to-weight ratio, safety of use, and other advantages, metal-air, and particularly zinc-air, batteries have been proposed as a preferred energy source for use in electrically powered vehicles. However, just like aluminum-air cells, zinc-air batteries also suffer from the problem of “passivation”, in this case, by the formation of a zinc oxide layer that prevents the remaining anode active material (Zn) from contacting the electrolyte.

A number of techniques have been proposed to prevent degradation of battery performance caused by zinc oxide passivation or to somehow extend the operating life of a metal-air battery. In one approach, a sufficient (usually an excessive) amount of electrolyte was added to allow most of the zinc to dissolve (to become Zn ion and thereby giving up the desired electrons). The large amount of electrolyte added significantly increased the total weight of the battery system and, thereby, compromising the specific energy density (energy per unit weight).

In a second approach, anodes were made by compacting powdered zinc onto brass current collectors to form a porous mass with a high surface/volume ratio. In this configuration, the oxide would not significantly block further oxidation of the zinc, provided that the zinc particles were sufficiently small. With excessively small zinc particles, however, zinc was rapidly consumed due to self-discharge and leakage (regardless if the battery is in use or not) and, hence, the battery will not last long.

In a third approach, particularly for the development of metal-air batteries as a main power source for vehicle propulsion, focus has been placed on “mechanically rechargeable” primary battery systems. Such a system normally comprises a consumable metal anode and a non-consumable air cathode, with the metal anode being configured to be replaceable once the metal component therein is expended following oxidation in the current-producing reaction. These systems constituted an advance over the previously-proposed secondary battery systems, which have to be electrically charged for an extended period of time once exhausted, and require an external source of direct current. However, most of these mechanically rechargeable systems are quite complex in construction.

Mechanically rechargeable metal-air batteries with mechanically replaceable anodes have been developed particularly for use in electric vehicle propulsion, since they facilitate quick recharging of the vehicle batteries simply by replacing the spent anodes, while keeping the air cathodes and other battery structures in place. This mechanical recharging, or refueling, may be accomplished in service stations dedicated to that purpose. However, it is necessary to provide metal-air battery cells that will repeatedly allow insertion and removal of the zinc anode elements for each charge/discharge cycle without causing wear and tear to the mechanically sensitive air electrode flanking each zinc anode.

Another approach to extending the discharge life of a metal-air battery is the “variable-area dynamic anode” method proposed by Faris (e.g., U.S. Pat. No. 5,250,370, Oct. 5, 1993). Such a battery structure includes electrodes, which are moved relative to each other during operation. The electrodes also have areas that are both different in size, with ratios that are variable. The battery structure includes a first electrode, which is fixed in a container. A second electrode is moved past the fixed electrode in the container and battery action such as discharge occurs between proximate areas of the first and second electrodes. A third electrode may be provided in the container to recharge the second electrode as areas of the second electrode are moved past the third electrode at the same time that other areas of the second electrode are being discharged at the first electrode. The ratio of the third electrode area to the first electrode area is much larger than 1, resulting in a recharge time that is much faster, thereby improving the recharge speed. However, this battery structure is very complicated and its operation could present a reliability problem.

Attempts to extend the operating life of a metal-air battery also include the utilization of a deferred actuated battery system, e.g., B. Rao, et al. (e.g., U.S. Pat. No. 4,910,102, Mar. 20, 1990), J. Ruch, et al. (U.S. Pat. No. 4,490,443, Dec. 25, 1984), McCarter (U.S. Pat. No. 5,340,662, Aug. 23, 1994), and Khasin, et al. (U.S. Pat. No. 5,424,147, Jun. 13, 1995). Intermittent transfer of electrolyte between cells and a reservoir was proposed by Flanagan (U.S. Pat. No. 5,472,803, Dec. 5, 1995). The above-cited batteries proposed by Rao, et al. and by Flanagan have the following drawbacks: These batteries involve the operation of a complicated electrolyte delivery system. Further, the deferred actuated battery system proposed by Rao, et al. relied upon a manual actuation operation, not a programmed-timing one. No predetermined criterion or logic was employed to automatically determine if and when a cell should be actuated. Actuation was effected by introducing electrolyte into the anode chamber (not in a programmed-timing fashion and not carried out in an automated manner). Furthermore, no “air admittance on demand” concept was utilized in these batteries; the cell was exposed to the outside air at all times.

In U.S. Pat. No. 5,569,551 (Oct. 29, 1996) and U.S. Pat. No. 5,639,568 (Jun. 17, 1997), Pedicini, et al. proposed the use of an anode bag to limit self-discharge of the cell in an attempt to maintain the capacity of the cell. It was stated that, by wrapping the anode in a micro-porous membrane that is gas-impermeable and liquid-permeable, oxygen from the ambient air that has seeped into the cell must go through a solubility step before it can pass through the anode bag to contact and discharge the anode. However, this solubility step is often not a slow step particularly when the oxygen or air ingress rate into the cell is high. This anode bag provides only a moderately effective approach to reducing the self-discharge problem. This is achieved at the expense of making the cell structure very complicated.

Mathews, et al. (U.S. Pat. No. 4,177,327, Dec. 4, 1979) recognized the importance of intermittently switching on/off an air vent to a metal-air battery for an improved operating life. An electrical actuator is activated to open the air vent only when the battery is supplying electric power to a load. In this manner, the battery is not open to the possibility of harsh ambient conditions such as very high or very low ambient relative humidity and prolonged carbon dioxide exposure unless when it is in use. However, in the batteries proposed by Mathews, et al. and others cited above, a switch or valve must be manually operated to turn on and off an air access vent and the timing at which this on/off operation is carried out must be determined by the user of the external device. Quite often, this user does not know if the battery in operation is running low in power and should be replaced or recharged immediately. Further, these prior-art batteries are each composed of an assembly of metal-air cells connected in series (e.g., in Mathews, et al., U.S. Pat. No. 4,177,327) and they do not address the issues of timing at which an individual cell assembly is actuated.

A particularly promising approach to the reduction of anode passivation and self-discharge problems and, hence, much enhanced battery operating life and better utilization of the anode material has been developed by one of the present applicants (Huang) and his colleague (J. Liu and W. C. Huang, “Metal-Air Battery with an Extended Service Life,” U.S. patent pending (Ser. No. 10/105,495) Mar. 26, 2002 and W. C. Huang, “Metal-Air Battery with Programmed-Timing Activation,” U.S. patent pending (Ser. No. 10/431,661) May 9, 2003). This approach entails constructing a battery that has a control circuit and a plurality of metal-air cell assemblies that are electronically connected in parallel. Each cell assembly comprises a casing with a controllable air vent thereon and at least a metal-air cell inside the casing. In the application of Liu and Huang, the controllable air vent is closed during the battery storage period. The air vent is opened in response to a programmed signal in order to allow outside air to enter the assembly through the air vent to activate the operation of the corresponding cell assembly. In the second application (Huang), the anode is initially isolated from the liquid electrolyte and, in a preferred embodiment, the air vent is also closed during the initial storage and transportation periods. The air vent and the liquid electrolyte valve are opened in a programmed-timing fashion. This actively controlled battery, making use of an “air admittance on demand” strategy or/and an “anode-electrolyte contact on demand” strategy, has exhibited an exceptionally long operating life. In this approach, individual cells will not be activated until they are needed. This design allows only selected assemblies to admit air into the cells and to have their anode material exposed to the electrolyte, leaving other cells un-activated and free from parasitic corrosion or self-discharge problems. Once activated, however, an individual cell will still be subjected to the undesirable self-discharge effects during the subsequent intermittent non-usage periods. The present invention addresses the self-discharge issues by allowing only a desired or minimal amount of anode material at a time to be in ionic contact with a liquid electrolyte and/or by exposing a cell to outside air only when oxygen is needed for cell operations (e.g., to produce the required hydroxide ions, OH⁻, in a metal-air cell).

Therefore, it is an object of the present invention to provide a smart battery that is composed of at least a metal-air cell in which only a desired amount or minimum amount of anode active material is activated at a time in a programmed-timing fashion. This activation step may be accomplished by dispensing a small amount of anode powder or advancing a small segment of anode metal wire or strip into a liquid electrolyte, or by stripping off a small amount of plastic separator tape (that initially isolates the anode from the electrolyte) so that a controlled and generally small amount (preferably an infinitesimally small amount) of anode comes in contact with the electrolyte at a time. This strategy is hereinafter referred to as “minimal anode-electrolyte contact on demand” strategy.

Another object of the present invention is to provide an actively controlled electrochemical cell and a smart metal-air battery containing such a cell that makes use of both the “air admittance on demand” and “minimal anode-electrolyte contact on demand” strategies.

It is still another object of the present invention to provide a cell or battery that exhibits little or no anode passivation, anode corrosion, or other self-discharge or current leakage problems.

A specific object of the present invention is to provide a metal-air cell or battery that has a long storage life and a long operating life.

### SUMMARY OF THE INVENTION

This invention provides an actively controlled electrochemical cell or a smart battery containing such a cell with a programmed-timing activation capability. As a preferred embodiment, the cell includes (a) a cathode, an anode, a porous separator electronically insulating the cathode from the anode, and an electrolyte, wherein the anode is initially isolated from the electrolyte fluid prior to first use of the cell; (b) an actuator in actuation relation to the electrolyte or the anode; and (c) a control device in control relation to the actuator for sending programmed signals to the actuator to activate the cell by allowing a desired amount of an active anode material at a time to be exposed to the electrolyte during the first use and/or successive uses of the cell. The battery has an essentially infinite shell life and an exceptionally long operating life. The battery is particularly useful for powering microelectronic or communication devices such as mobile phones, laptop computers, and palm computers.

In the case of a metal-air cell, the cathode is an air cathode and the anode includes an element selected from the group consisting of alkali elements, alkaline earth metal elements, aluminum, zinc, iron, chromium, manganese, and titanium.

The electrochemical cell may further comprise a casing that houses the anode, cathode, and separator, wherein the casing comprises a controllable air vent thereon to admit ambient air into the cell on demand or in a programmed-timing fashion. The air vent is controlled by an air vent actuator that receives programmed signals from the control device. Preferably, the air vent is sealed prior to first use of the cell. The air vent is preferably re-closeable and is re-closed responsive to a programmed signal from the control device. Specifically, the air vent is re-closed when a voltage, current, or power output of the cell exceeds a predetermined high threshold voltage, current, or power.

In one preferred embodiment, the anode active material is an elongate member initially isolated from the electrolyte and the step of allowing a desired amount of an active material to be exposed to the electrolyte is accomplished by operating the actuator, responsive to the programmed signals, to incrementally advance the elongate member, one small segment at a time, into a chamber containing the electrolyte.

In another embodiment, the anode comprises an active anode material in a powder form contained in a powder chamber disposed in the vicinity of the electrolyte and in a supplying relation to the electrolyte and the step of allowing a desired amount of an active anode material to be exposed to the electrolyte is accomplished by operating the actuator, responsive to the programmed signals, to incrementally dispense a desired amount of the powder into a chamber containing the electrolyte.

The actuator may comprise an actuator element selected from the group consisting of a bi-metal device, a thermo-mechanical device, a piezo-electric device, a shape memory alloy, an electromagnetic element, a positive displacement piston, a drive roller, a motor, and combinations thereof. The control means preferably comprises a sampling unit and a logic circuit to determine the timing at which a desired amount of an active anode material is exposed to an electrolyte. Preferably, the electrochemical cell further comprises a power-control unit to regulate the power input to the logic circuit, wherein the power input is switched off to conserve cell power after the control unit determines that actuator operation is no longer needed at a given moment of time. Preferably, the actuator is operative when a voltage, current, or power output of said cell, when in use, drops to below a predetermined low threshold voltage, current, or power.

Another embodiment of the present invention is a battery kit in which the electrochemical cell assembly is initially separated from the control circuit assembly. At the moment of the first battery use, the two assemblies are connected together so that the control circuit may begin to control the operations of the cell assembly. The control circuit assembly may be pre-assembled within an electronic device (e.g., built into a cell phone or a notebook computer), which has a trough to receive the matting electrochemical cell assembly. The electrochemical cell assembly part is later slided into this trough to begin the battery operation. When the anode material in this cell assembly is exhausted, the cell assembly may be pulled out and replaced with another cell assembly, much like re-loading a roll of photographic film in a camera.

### BRIEF DESCRIPTION OF THE DRAWINGS

FIG. 1(A) Schematic of a metal-air cell assembly in an actively controlled battery, (B) a roller cartridge-style active anode material in the form of multiple parallel strips of anode film, and (C) anode material configuration similar to (B) but a strip is composed of individual segments of anode film.

FIG. 2 Schematic of a multiple-strip anode-cathode-electrolyte cell configuration.

FIG. 3 Schematic of a control unit used in the battery of FIG. 1.

FIG. 4 Schematic of a sampling unit.

FIG. 5 Schematic of a power control unit.

FIG. 6 Schematic of a driver unit.

FIG. 7 Schematic of a logic control unit.

FIG. 8 Schematic of a battery kit.

### DESCRIPTION OF THE PREFERRED EMBODIMENTS

For the purpose of describing a preferred embodiment, lithium (Li) is used as an example for the anode material. However, it may be noted that anode may include an element selected from the group consisting of alkali elements, alkaline earth metal elements, aluminum, zinc, iron, chromium, manganese, and titanium. Both aqueous and non-aqueous organic electrolytes (e.g., those proposed by Abraham and Jiang, U.S. Pat. No. 5,510,209, Apr. 23, 1996) may be used to prepare Li-air cells according to the presently invented battery design.

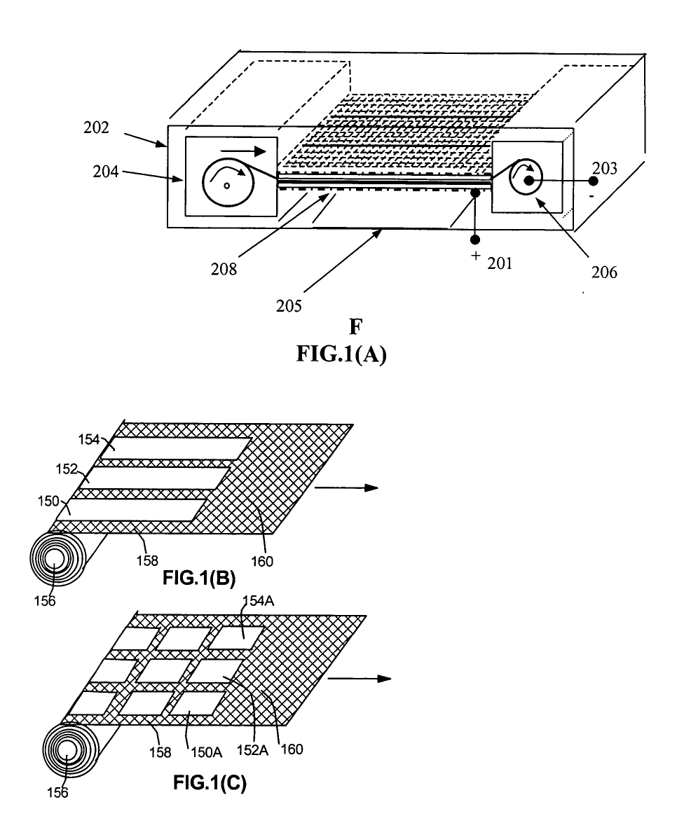

As a preferred embodiment of the present invention, the main body of an actively controlled battery, schematically shown in FIG. 1(A), contains a desired number (n) of parallel-aligned, but physically separated strips of lithium anode (e.g., 150, 152, 154 in FIG. 1(B)). These parallel thin strips of lithium metal may be supported on a porous backing paper or plastic substrate as a carrier 158. The strips and their carrier are preferably configured into a roll of anode film wound on a shaft 156. This roll of anode film is placed in an anode chamber 204, which is well-sealed from an electrolyte chamber 208 (FIG. 1(A)). These strips may be fed, on demand, into the electrolyte chamber, one small segment at a time for each strip during periods of battery operation. This electrolyte chamber is free of electrolyte fluid during the initial battery storage period and will be filled with an electrolyte fluid immediately prior to the first use of the battery. Inside this electrolyte chamber, each strip is in physical contact with a current collector, which may be a conductive screen or mesh. There will also be a corresponding air cathode and cathode current collector. One strip segment of Li metal film, the electrolyte, and a similarly sized air cathode together constitute a metal-air cell. In general, these n cells are connected in series to provide a desired voltage (nVₒ, where Vₒ is the practical working voltage of a metal-air cell, which is less than the theoretical 3.4 V for a Li-air cell). Feeding of these parallel strips of Li metal can be actuated in a programmed-timing fashion according to desired current, voltage and/or power needs.

An initial amount of Li anode material (e.g., a first segment of Li film for each strip) may be placed inside the electrolyte chamber during the storage period, provided that the chamber contains no electrolyte fluid and is free from atmospheric air. The electrolyte chamber may contain no electrolyte (no fluid such as water and no other electrolyte solid ingredient such as NaCl and KOH) or, alternatively, the chamber may contain some solid ingredients (that do not react with the anode material), but no electrolyte fluid. In either case, just prior to the first use, a desired amount of electrolyte fluid is allowed to flow into the electrolyte chamber and atmospheric air is admitted into the cell assembly.

Alternatively, the electrolyte chamber may contain the electrolyte, but no Li anode material, during the storage period. The first segment of Li film for each strip is fed into the chamber and atmospheric air is admitted into the cell assembly just prior to the first use of the battery. The second and successive segments of Li film remain free of electrolyte fluid and atmospheric air. A control circuit is on board to determine if and when additional amounts of Li anode material are needed. In particular, when the control circuit determines that the first segments of Li film are no longer capable of providing an adequate level of current, voltage, and/or power, additional amounts of Li material are fed into the electrolyte chamber to join the previously activated first segments for powering an external device.

The activation of existing or additional segments of anode material is accomplished by (a) allowing the anode to come in contact with the needed electrolyte (the “anode-electrolyte contact on demand” strategy) and/or (b) turning on an air-vent control valve to admit outside air (the “air admittance on demand” strategy). Additional amounts of anode material will not be activated until the previously activated anode materials are essentially fully consumed or are no longer capable of providing a desired level of voltage, current, and/or power.

The presently invented smart lithium-air battery that makes use of both the “air admittance on demand” and “anode-electrolyte contact on demand” strategies is subject to minimal anode passivation, self-discharge, current leakage, or anode corrosion problems (including the problems caused by air-borne moisture to Li anode) since the anode is not in contact with the electrolyte fluid or atmospheric air until needed. Hence, these strategies make it possible to make essentially full utilization of the anode materials in a cell. This approach provides a lithium-air battery that has an essentially infinite long storage life and an exceptionally long operating life.

Preferably, each battery includes at least two strips of anode with the resulting cells electronically connected in series. However, there can be any desired number of strips in a roll to meet a voltage, current and/or power requirement. The surface areas of the strip segments of anode material that are fed into the electrolyte chamber dictate the current magnitude and power (with a given voltage value since P=IV). The cell assembly includes a casing that houses a feed roller chamber, an electrolyte chamber, and a take-up roller chamber. A small drive motor or other type of actuator may be strategically located outside the casing, but can be readily engaged with either the feed roller or the take-up roller for the purpose of moving the anode film on demand. The casing also has a controllable air vent that is closed during the initial battery storage period. This air vent can be readily opened and preferably can be re-sealed responsive to programmed signals from the control circuit. During the initial storage period, the anode in all of the strips is isolated from the electrolyte and air. This isolation is accomplished by initially placing the anode and the electrolyte fluid in two separate compartments, as described earlier.

The voltage, current, or power output level may be monitored continuously or intermittently by a control circuit for the purpose of determining if and when additional amounts of anode material should be activated. When it is logically determined that additional amounts of anode are needed, the circuit will send a programmed signal to advance the anode film. Specifically, additional amounts of anode material will be fed into the electrolyte chamber when the voltage, current, or power output of the battery in operation drops below a predetermined low threshold value.

The electrolyte fluid access door and the air vent are designed in such a fashion that they can be opened manually prior to the first battery use and the air vent may be re-closed or re-opened either manually or automatically according to a programmed logic. The actuator to open/close the air vent may include an actuator element such as a bi-metal device, a thermo-mechanical device, a piezo-electric device, a shape memory alloy, or an electromagnetic element.

Preferably, the control circuit includes a sampling unit and a logic circuit to determine the timing at which additional amounts of anode are fed into the electrolyte chamber and the timing at which an air vent is opened or re-closed. Further preferably, the battery is also equipped with a power control unit to regulate the power input to the logic control unit and to autonomously switch off the power input to circuit elements other than the sampling unit in order to conserve the battery power after the control unit determines that no opening/closing of the air vent and no anode feeding is needed for the time being. The sampling unit, which is designed to draw a minimal amount of current, is allowed to stay on at all times after the first use of the battery.

The “air admittance on demand” strategy serves to reduce or eliminate potential anode passivation, cell self-discharge and current leakage, and corrosion problems caused by atmospheric water vapor. The “anode-electrolyte contact on demand” strategy serves to reduce or eliminate potential anode passivation and corrosion problems.

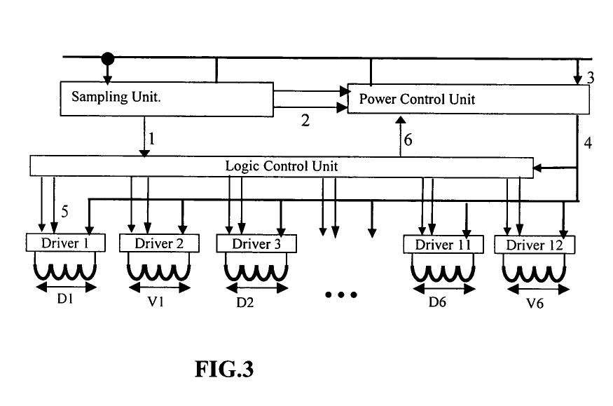

The preferred battery design consists of a main body (FIG. 1) and its electronic control unit (FIG. 3). A protective circuitry, C1, serves to protect the battery just in case the cell assembly is short-circuited. It may also be a voltage-regulating circuit that serves to condition or adjust the output voltage. A controllable air vent D1, which is driven by a driver (e.g., an electromagnetic actuator device), acts as an access path for outside air. A roller, driven by a driver R1, pulls the anode material into the electrolyte chamber from an anode chamber. All the anode strips in one assembly may be configured to share one electrolyte reservoir. Alternatively, individual strips may be allowed to enter separate electrolyte fluid compartments. The air vent and electrolyte valve preferably can be readily opened manually and, further preferably, the air vent can be re-sealed either manually or automatically.

The battery may include a control circuit for sending programmed signals to feed additional amounts of anode material into the electrolyte chamber and to open or close up the air vent in a programmed fashion. The most ideal situation is to activate an exact amount of anode material that is needed to contribute to the provision of power to an external load (a device or appliance such as a mobile phone or laptop computer). In a continuous usage situation, it is desired that most, if not all, of the power in the first segments of anode material is fully utilized before second segments are activated. When not in use, the remaining portions of the anode strips are isolated from outside air and electrolyte fluid to reduce undesirable effects such as self-discharge, oxidation, passivation, and corrosion.

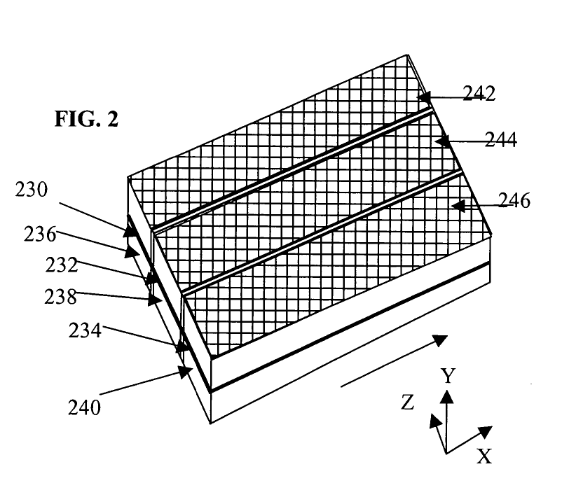

FIG. 1 and FIG. 2 show one design example of a lithium-air cell assembly with an actively controlled anode. This assembly contains an air access port 205, a container 202, and two anode chambers 204, 206 on the left and right side, respectively, which are separated by an electrolyte chamber 208. The anode material is allowed to contact with electrolyte only in the electrolyte chamber. A larger anode surface area in contact with the electrolyte allows the cell to provide more current and thus more power to the external device. The distance between the left and right anode chamber, which sets the upper current and power limits, is predetermined by the power requirement.

Connectors 201 and 203 extended from the container body 202 are in electrical contact with an air cathode and an anode strip, respectively. They are in turn connected to the pairing connectors of other cells in the same assembly to provide a desired voltage output level. FIG. 2 schematically shows three separate anode strips 230, 232, 234 entering three separate electrolyte zones 236, 238, 240, which are connected to three air cathodes 242, 244, 246. Each anode strip is electrically separated from other strips on the same anode roll. In this configuration, insulating gaskets are positioned between electrolyte zones, which may receive electrolyte fluid from three separate fluid access doors or valves.

FIG. 3 schematically shows an example of the electronic control unit for use in the presently invented battery. It is made up of a sampling unit, a power control unit, a logic control unit, and three drivers for the three respective actuators. The actuators shown here are electromagnetic devices that can undergo sliding or rotational motions to open/close the controllable air vent and the electrolyte access door, and to advance the strips of anode. Connection 1 is for sending high and low limit signals from the sampling unit to the logic control unit. Connection 2 is for sending the control driving signals from the sampling unit to the power control unit, which has a power switch function. Connection 3 connects the positive and negative poles of the battery leads to the power control unit. Connection 4 feeds the output of the power control unit, through the power lines of the battery, to the logic control unit and all the drivers for providing power thereto. Connection 5 (with three connecting wires forming a set per driver) is for the control signals from the logic control unit to a driver. Preferably, there are at least three drivers per cell assembly: air vent driver (e.g., D1) electrolyte fluid valve driver (e.g., V1), and roller driver (e.g., R1). Each air vent driver drives its corresponding actuator to open or close the air vent while each electrolyte valve driver drives its actuator to open the electrolyte valve. Each roller driver drives its roller to advance additional segments of the anode material into the electrolyte chamber. If a full amount of electrolyte fluid is added to the electrolyte chamber at the first time, then it is not necessary to re-close the electrolyte fluid valve once opened. Alternatively, one may choose to add an incremental amount of electrolyte fluid into a fluid chamber when additional anode segments are fed into the chamber.

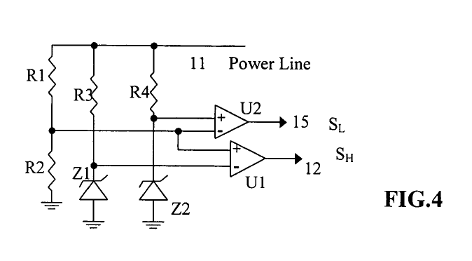

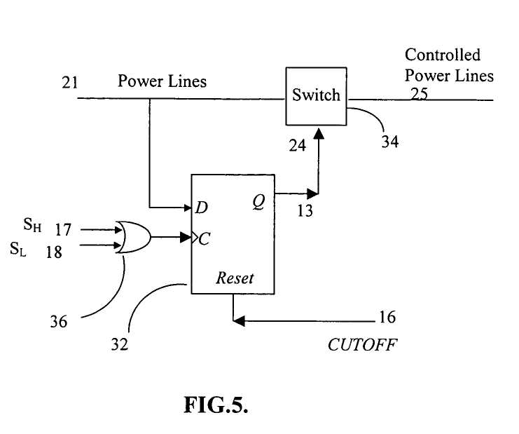

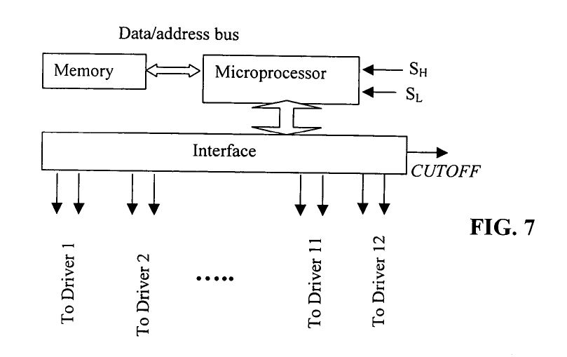

An example of a circuit for the sampling unit, shown in FIG. 4, consists of sampling resistors R1 and R2, reference circuits R3 and Z1, and R4 and Z2, and comparators U1 and U2. Terminal 12, the S_{H} signal, and terminal 15, the S_{L} signal, representing the voltage change of the battery, lead to terminals S_{H} and S_{L} in FIG. 7. Terminal 11 is a power line that is connected to terminal 21 of the power control unit, schematically shown in FIG. 5.

The power control unit, illustrated in FIG. 5, consists of an OR gate 36, a switch 34 and a type D flip-flop 32. The switch can be a mechanical contact relay, a solid-state relay, or any other switch device driven by electricity. FIG. 5 includes a switch constructed with MOS P-channel and N-channel enhancement mode devices in a single monolithic structure. A single control signal 24 is required for the switch. Both the p and the n device in the switch are biased on or off simultaneously by the control signal. Terminal 21 is the power line from the sampling unit shown in FIG. 4. The D-type flip-flop 32 has Data (D), Reset, and Clock (C) as input terminals and Q as output. A high level at the Reset input clears the output Q regardless of the level of the other input. When Reset is inactive (low), data at the D input are transferred to the outputs only on the positive-going edge of the clock pulse. Data at the D input may be changed without affecting the level at the output. Table 1 shows the truth table of a type D flip-flop. Terminal 24 accepts the actuating signal from the type D flip-flop 32 to actuate the switch for connecting or disconnecting the power supply from the battery. Terminal 25 indicates the power line from the switch to the logic control unit and all the drivers (see connection 4 in FIG. 3).

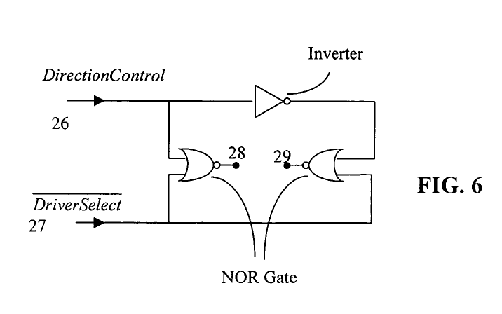

Terminal 13 is for the driving signal that is connected to terminals 24 of the switch. Terminal 16 connected to the Reset input of the flip-flop accepts the “CUTOFF” signal from the logic control unit in FIG. 6 to reset the flip-flop. Terminals 17 and 18 accept the S_{L} and S_{H} signals from the sampling unit to actuate the switch for connecting or disconnecting the power supply from the battery.

TABLE 1
Truth table of a type D flip flop.

| Inputs | | | Outputs |
|---|---|---|---|
| Reset | Data | Clock* | Q |
| 1 | X | X | 0 |
| 0 | 1 | 0 → 1 | 1 |
| 0 | 0 | 0 → 1 | 0 |
| 0 | X | 1 → 0 | Q (No Change) |

X = Don't Care;
*Level Change

Typically, a battery is submitted to either “continuous-use” or “intermittent use” conditions.

Case 1: Continuous Use of a Battery: To begin the battery operation, the air vent D1 may be manually switched open. The electrolyte valve to the cell assembly may also be switched open, e.g., in its simplest case, by removing a separator between a fluid reservoir and the electrolyte chamber. These two steps will allow electrolyte to flow into the electrolyte chamber and allow outside air to enter the air cathode inside the battery casing to initiate the battery operation.

Once activated, the first segments of anode material will produce some electricity. However, with a high power demand level, its output voltage may be less than U_{L}, a lower limit predetermined by a battery designer or manufacturer. (Alternatively, a current or power level, or a combination of voltage, current, and power values mat be used as a criterion.) In this situation, the sampling unit in FIG. 3 will sense the voltage, send control-driving signals to the power control unit through connection 2, and make the power control unit work to send power to the logic control unit and drivers through connection 4. Then, the powered logic control unit checks the signals from the sampling unit through connection 1, carries out an internal calculation, and sends control signals to driver 1 through connection 5. The actuator R1 (e.g., a motor), driven by driver 1, acts to feed additional segments of the anode material into the electrolyte chamber. After a few seconds, the output voltage will reach or exceed U_{L}. The logic control unit will sense it and send a “CUT-OFF” signal to the power control unit through connection 6. The power control unit receives the signal and stops supplying the logic control unit and drivers with power. From this moment on, the battery stays in a normal condition to power an external electric appliance or device.

After a first continuous usage period (e.g., a week or so), the first segments almost run out of their energy, the output power can no longer meet the external demand, and the output voltage will drop to below U_{L}, for instance. The sampling unit will sense the change and inform the power control unit to power up the logic control unit. The logic control unit checks the signals from the sampling unit through connection 1 (see FIG. 3). If the logic control unit determines that the battery output voltage indeed drops below U_{L}, it will send control signals to pull the roller R1, which feeds segments of fresh anode material into the electrolyte chamber. After a few seconds, the output voltage will rise again. If the voltage is over U_{L}, the logic control unit will send a “CUT-OFF” signal to the power control unit through connection 6 for turning off the switch in power control unit. From the moment on, the battery stays again in a normal condition to power an external device.

The above procedures are repeated until the roll of anode material is fully exhausted. After the battery cannot meet the power demand of the external electric device, it will be thrown away, recharged, or replenished (e.g., replaced with another roll of anode material, without discarding or replacing the control circuits).

Case 2: Intermittent Use: The initial startup procedure of a battery for the intermittent use is similar to that for the continuous usage case. If the battery is not going to be used for a while (after a previous usage period), the air vent should preferably be closed to prevent atmospheric air from entering the cell in order to prolong the service life of the battery. The sampling unit, as shown in FIG. 3, can respond to the power demand change by sensing the voltage fluctuation when an external circuit does not drain any further current from the battery. This would result in a battery output voltage being over U_{H}, a predetermined upper limit defined by battery designers. After the sampling unit detects this voltage fluctuation, it sends a control signal to the power control unit, which is instructed to power the logic control unit and all drivers. The powered logic control unit again reads the S_{H} signal received from the sampling unit through connection 1 to make sure the voltage is still over U_{H}. If it is over U_{H}, the unit will send control signals to the air vent driver to close the air vents D1. Then, the unit will send a “CUT-OFF” signal to the power control unit for cutting off the power supply to the logic control unit and all drivers. The remaining unexposed anode stored in the anode chamber does not need any special operation during the step of tentatively putting the battery into a dormant state.

After some time, the user may want to re-use the battery again. As such, when the electric appliance is re-connected to the battery, the output voltage of the battery will drop sharply to below U_{L} due to no air entering the cell. At this moment, a similar procedure as described above will be initiated to open up air vent D1 and activate roller driver R1. After 3 seconds or so, the logic control unit in FIG. 3 will read the signal from the sampling unit through connection 1 and judge whether it is over U_{L}. If it is still below U_{L}, the control unit as shown in FIG. 3 will activate roller driver R1 to feed additional amounts of fresh anode material into the electrolyte chamber. After 3 seconds again, if the voltage is still below U_{L}, the unit activates roller driver R1 again; these procedures are repeated until the battery provides an adequate power and a proper battery voltage output is achieved (e.g., U_{L}≦V≦U_{H}).

During the above-described operation, if the voltage detected by the sampling unit is over U_{L}, the unit will withdraw S_{L} signal from the logic control unit causing the latter to send a “CUT-OFF” signal to the power control unit for turning off the power to the logic control unit and all drivers. The battery is now in a normal status of continually supplying the outer electric appliance with power.

In the above description, as a preferred embodiment, the anode active material is in the form of a strip or multiple strips of anode film. In general, an elongate member (a rod, plate, etc.) or multiple elongate members may be initially isolated from the electrolyte and the step of allowing a desired amount of an active material to be exposed to the electrolyte is accomplished by operating the actuator, responsive to the programmed signals, to incrementally advance the elongate member(s), one small segment at a time, into a chamber containing the electrolyte.

In another preferred embodiment, the anode comprises an active anode material in a powder form contained in a powder chamber disposed in the vicinity of the electrolyte chamber and in a supplying relation to the electrolyte chamber. The step of allowing a desired amount of an active anode material to be exposed to the electrolyte is accomplished by operating the actuator, responsive to the programmed signals, to incrementally dispense a desired amount of the powder into a chamber containing the electrolyte. There can be several electrolyte chambers, one for each cathode-anode couple along with its current collectors and separators to form one electrochemical cell. These several cells are connected in series, in parallel, or both to provide a desired voltage, current or power.

In another preferred embodiment, any of the above described battery configurations may be arranged in a “kit” form, in which the control circuit assembly (including the drive motor and the actuators for air vent and electrolyte fluid valve) is initially separated from the physical body of the electrochemical cells (e.g., containing the feed roller and a roll of anode film, the electrolyte chamber, the take-up roller, cathodes, current collectors, separators, and a casing). The control circuit assembly may be pre-connected to an electrical appliance or electronic device (e.g., a computer). The external surface of this control circuit assembly may form a trough to receive the physical body of the cells, referred to as the cell assembly. The trough may be designed in such a fashion that the cell assembly can easily slide into and out of the trough for replenishing and removing the cell assembly, respectively.

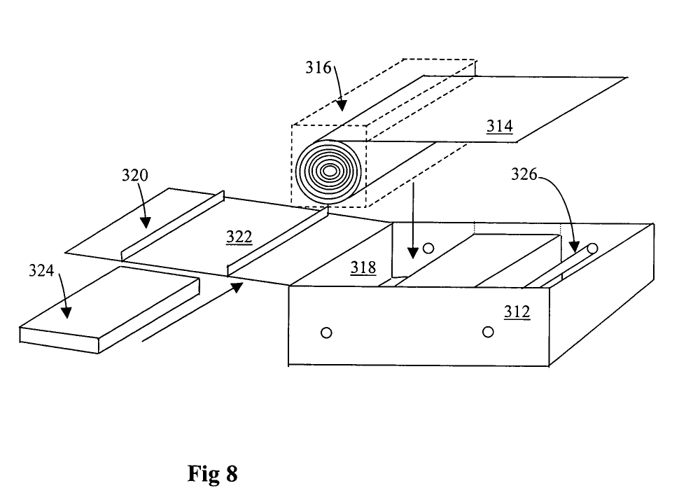

In another preferred embodiment as shown in FIG. 8, the consumable part in the electrochemical cell can be arranged in a “kit” form for easy replacement, which includes an electrolyte chamber and a roll of anode film. The battery casing 312 can be flipped open to allow easy access. The anode film 314 stored in an anode container 316 can be readily loaded into the anode chamber 318. The leading edge of the anode film will be engaged with the roller 326. The battery casing cover 320 may form a trough 322 to receive an electrolyte chamber or pouch 324.

Immediately prior to the first use of the battery, the cell assembly is positioned in the trough of the control circuit assembly in such a fashion that the cell assembly is now under the control of the control circuit assembly. For instance, the feed roller is now engaged with a drive motor, which is ready to advance a roll of anode film on demand. The operator may now manually open an air vent to admit the outside air and turn on the fluid valve (or break a thin wall) to allow the electrolyte fluid (originally in a separate reservoir) to enter the electrolyte chamber to come in contact with the first segments of the anode material (which, in this case, are already inside the electrolyte chamber). Alternatively, in the case where the electrolyte fluid is already inside the electrolyte chamber (but the first anode segments are still outside of the electrolyte chamber), the operator may simply pull a carrier plastic substrate forward so that the first segments of the anode film are now moved into the electrolyte chamber to activate the battery. The control circuit will do the rest of the battery functions autonomously.

The presently invented smart battery with controlled activation timing achieves the following three technical goals: (a) isolation of the anode material from the electrolyte fluid or atmospheric air during the battery storage period, leading to a practically indefinitely long shelf life; (b) only a minimal amount of active anode material is activated at a time in a programmed fashion; and (c) isolation of the remaining anode active material in a roll from the electrolyte and the atmospheric air so that no significant parasitic anode reaction will occur, resulting in sustained (intermittent, continuous, or otherwise programmed) use of a battery for a very long duration of time. Further, in the case of a lithium or sodium based cell, the present “air admittance on demand” strategy effectively reduces or eliminates the danger associated with the potentially violent lithium or sodium reactions induced by air-borne moisture.

1. An actively controlled electrochemical cell, comprising
(a) a cathode, an anode, a porous separator electronically insulating said cathode from said anode, and an electrolyte comprising a fluid component, wherein said anode is initially isolated from said electrolyte fluid prior to first use of said cell;
(b) actuator means in actuation relation to said electrolyte fluid or said anode; and
(c) control means in control relation to said actuator means for sending programmed signals thereto to activate said cell by allowing a desired amount of an active anode material at a time to be exposed to said electrolyte fluid during said first use and/or subsequent uses of said cell.

2. The electrochemical cell as set forth in claim 1, wherein said anode comprises a metal element selected from the group consisting of alkali elements, alkaline elements, lithium, magnesium, aluminum, zinc, titanium, chromium, manganese, iron, and cadmium.

3. The electrochemical cell as set forth in claim 1, wherein said cell comprises a metal-air cell in which said cathode is an air cathode and said anode comprises an element selected from the group consisting of alkali elements, alkaline earth metal elements, aluminum, zinc, iron, and titanium.

4. The electrochemical cell as set forth in claim 3, further comprising a casing that houses said anode, cathode, and separator, wherein said casing comprises a controllable air vent thereon to admit ambient air into said cell on demand or in a programmed-timing fashion, said air vent being controlled by an air vent actuator means receiving programmed signals from said control means.

5. The electrochemical cell of claim 4, wherein said air vent is sealed prior to first use of said cell.

6. The electrochemical cell as set forth in claim 1 or 4, wherein said anode active material comprises at least an elongate member initially isolated from said electrolyte and said step of allowing a desired amount of an active material to be exposed to said electrolyte fluid is accomplished by operating said actuator means, responsive to said programmed signals, to incrementally advance said elongate member, one small segment at a time, into a chamber containing said electrolyte.

7. The electrochemical cell as set forth in claim 1 or 4, wherein said anode comprises an active anode material in a powder form contained in a powder chamber disposed in a vicinity of said electrolyte and in a supplying relation to said electrolyte and said step of allowing a desired amount of an active anode material to be exposed to said electrolyte is accomplished by operating said actuator means, responsive to said programmed signals, to incrementally dispense a desired amount of said powder, a small amount at a time, into a chamber containing said electrolyte.

8. The electrochemical cell as set forth in claim 1 or 4, wherein said anode active material comprises at least a strip of anode material film initially isolated from said electrolyte fluid and said step of allowing a desired amount of an active material to be exposed to said electrolyte fluid is accomplished by operating said actuator means, responsive to said programmed signals, to incrementally advance said strip of film, one small segment at a time, into a chamber containing said electrolyte.

9. The electrochemical cell as set forth in claim 1 or 4, wherein said actuator means comprises an actuator element selected from the group consisting of a bi-metal device, a thermo-mechanical device, a piezo-electric device, a shape memory alloy, an electromagnetic element, a positive displacement piston, a drive roller, a motor, and combinations thereof.

10. The electrochemical cell as set forth in claim 1 or 4, wherein said control means comprises a sampling unit and a logic circuit to determine the timing at which a desired amount of an active anode material is exposed to an electrolyte.

11. The electrochemical cell as set forth in claim 10, further comprising a power-control unit to regulate a power input to said logic circuit and wherein said power input is switched off to conserve cell power after said control unit determines that actuator operation is no longer needed at a given moment of time.

12. The electrochemical cell as set forth in claim 1 or 4, wherein said actuator means is operative when a voltage, current, or power output of said cell, when in use, drops to below a predetermined low threshold voltage, current, or power.

13. The electrochemical cell as set forth in claim 4, wherein said controllable air vent is re-closeable and is re-closed responsive to a programmed signal from said control means.

14. The electrochemical cell as set forth in claim 4, wherein said air vent is re-closed when a voltage, current, or power output of said cell exceeds a predetermined high threshold voltage, current, or power.

15. The electrochemical cell as set forth in claim 1 or 4, wherein said control means is operative based on a real time voltage, current or power requirement demanded by an external device or appliance.

16. A battery comprising at least an electrochemical cell as defined in claim 1 or 4.

17. A battery kit comprising, in combination:
(A) an electrochemical cell assembly comprising a cathode, an anode, a porous separator electronically insulating said cathode from said anode, and an electrolyte comprising a fluid component, wherein said anode is initially isolated from said electrolyte fluid prior to first use of said cell; and
(B) a control circuit assembly initially separated from said electrochemical assembly prior to said first use, said control circuit assembly comprising
(B1) actuator means in actuation relation to said electrolyte fluid or said anode when said electrochemical cell assembly and said control circuit assembly are connected at said first use; and
(B2) control means in control relation to said actuator means for sending programmed signals thereto to activate said cell assembly by allowing a desired amount of an active anode material at a time to be exposed to said electrolyte fluid during said first use and/or subsequent uses of said cell.

18. The battery kit as set forth in claim 17, wherein said anode comprises a metal element selected from the group consisting of alkali elements, alkaline elements, lithium, magnesium, aluminum, zinc, titanium, chromium, manganese, iron, and cadmium.

19. The battery kit as set forth in claim 17, wherein said cell comprises a metal-air cell in which said cathode comprises an air cathode and said anode comprises an element selected from the group consisting of alkali elements, alkaline earth metal elements, aluminum, zinc, iron, and titanium.

20. The battery kit as set forth in claim 19, further comprising a casing that houses said anode, cathode, and separator, wherein said casing comprises a controllable air vent thereon to admit ambient air into said cell on demand or in a programmed-timing fashion, said air vent being controlled by an air vent actuator means receiving programmed signals from said control means.

21. The battery kit of claim 20, wherein said air vent is sealed prior to first use of said cell.

22. The battery kit as set forth in claim 17 or 20, wherein said anode active material comprises at least an elongate member initially isolated from said electrolyte and said step of allowing a desired amount of an active material to be exposed to said electrolyte fluid is accomplished by operating said actuator means, responsive to said programmed signals, to incrementally advance said elongate member, one small segment at a time, into a chamber containing said electrolyte.

23. The battery kit as set forth in claim 17 or 20, wherein said anode comprises an active anode material in a powder form contained in a powder chamber disposed at a desired distance from said electrolyte and in a supplying relation to said electrolyte and said step of allowing a desired amount of an active anode material to be exposed to said electrolyte is accomplished by operating said actuator means, responsive to said programmed signals, to incrementally dispense a desired amount of said powder into a chamber containing said electrolyte.

24. The battery kit as set forth in claim 17 or 20, wherein said anode active material comprises at least a strip of anode material film initially isolated from said electrolyte fluid and said step of allowing a desired amount of an active material to be exposed to said electrolyte fluid is accomplished by operating said actuator means, responsive to said programmed signals, to incrementally advance said strip of film, one small segment at a time, into a chamber containing said electrolyte.

25. The battery kit as set forth in claim 17 or 20, wherein said actuator means comprises an actuator element selected from the group consisting of a bi-metal device, a thermo-mechanical device, a piezo-electric device, a shape memory alloy, an electromagnetic element, a positive displacement piston, a drive roller, a motor, and combinations thereof.

26. The battery kit as set forth in claim 17 or 20, wherein said control means comprises a sampling unit and a logic circuit to determine the timing at which a desired amount of an active anode material is exposed to an electrolyte.

27. The battery kit as set forth in claim 26, further comprising a power-control unit to regulate a power input to said logic circuit and wherein said power input is switched off to conserve the cell power after said control unit determines that actuator operation is no longer needed at a given moment of time.

28. The battery kit as set forth in claim 17 or 20, wherein said actuator means is operative when a voltage, current, or power output of said cell, when in use, drops to below a predetermined low threshold voltage, current, or power.

29. The battery kit as set forth in claim 20, wherein said controllable air vent is re-closeable and is re-closed responsive to a programmed signal from said control means.

30. The battery kit as set forth in claim 20, wherein said air vent is re-closed when a voltage, current, or power output of said cell exceeds a predetermined high threshold voltage, current, or power.

31. The battery kit as set forth in claim 17 or 20, wherein said control means is operative based on a real time voltage, current or power requirement demanded by an external device or appliance.

32. The battery kit as set forth in claim 17 or 20, wherein said control circuit assembly is pre-connected to an electrical appliance or electronic device.

33. The electrochemical cell as set forth in claim 4, wherein said casing can be opened and is opened for replacing the anode and/or electrolyte as desired.

34. The electrochemical cell as set forth in claim 8 and comprising a casing as defined in claim 4, wherein said anode film is initially stored in an anode container and loaded into the casing as desired.

35 The electrochemical cell as set forth in claim 1, wherein said electrolyte is initially stored in an electrolyte container and is loaded into said cell as desired.
